(19) United States
(12) Patent Application Publication
(10) Pub. No.: US 2003/0070716 A1
(43) Pub. Date: Apr. 17, 2003

(54) Microvalve

(75) Inventors: Metin Giousouf, Esslingen (DE); Michael Weinmann, Pluderhausen (DE)

Correspondence Address: Charles R. Hoffmann, Esq., HOFFMANN & BARON ,LLP, 6900 Jericho Turnpike, Syosset, NY, 11791, US

(73) Assignee: Festo AG & Co.

(21) Appl. No.: 10/247,925

(22) Filed: Sep. 20, 2002

(30) Foreign Application Priority Data
Oct. 15, 2001 (DE) 201 16 898.7

(51) Int. Cl. F15B 13/044

(52) U.S. Cl. 137/625.65

(57) ABSTRACT

A microvalve comprising a valve chamber defined by a housing, the valve chamber being connected with housing openings constituting fluid ducts. Within the valve chamber a valve member is arranged, which consists of an elongated actuator element secured at one point to the housing and on which at least one electrical conductor is applied, whose coefficient of thermal expansion, different to that of the actuator element, causes deflection of the valve member into at least one position. The top actuator element is manufactured of a plastic material.

### BACKGROUND OF THE INVENTION

The invention relates to a microvalve comprising a housing delimiting a valve chamber, such valve chamber being connected with housing openings forming fluid ducts, a valve member arranged within the valve chamber, such valve member being composed of an elongated actuator element attached at one point on the housing, and at least one electrical conductor arranged on the actuator element, the thermal expansion properties of the electrical conductor being different to those of the actuator element and causing deflection of the valve member into at least one position.

### THE PRIOR ART

The German patent publication 19,735,156 C1 discloses a piezoelectrically actuated microvalve in the case of which the valve member is thrust against a housing opening, when a piezoelectric element, applied to the actuator element, is changed in its extent by electrical control. Owing to the piezoelectric effect actuator element so bends that the housing opening is closed by the valve seat of the actuator element and accordingly the fluid duct connected with the housing opening is closed. This known microvalve may be simply operated by the piezoelectric effect and has small overall dimensions, is suitable for the control of the flow of a fluid.

In the case of the said microvalve in accordance with the German patent publication 19,735,156 C1 there is on the one hand the disadvantage that only one fluid circuit with a fluid inlet and a fluid outlet is able to be connected with the microvalve with the result that for example venting of the valve chamber is not possible when the first fluid circuit is locked. On the other hand the entire microvalve consists of materials such as metal or ceramic materials which are hard to machine with the necessary dimensions.

The prior art utilizes not only a microvalve with an actuator element able to be deflected by a piezoelectric effect toward a housing opening but also the expansion properties of an electrically heated conductor in relation to the actuator element in such a manner that the valve member is bent on heating the electrical conductor into a closed position, in which a valve seat shuts off the housing opening with fluid connections.

### SHORT SUMMARY OF THE INVENTION

One object of the present invention is to improve upon a microvalve of the type initially mentioned in such a manner that it is simple and economic to produce while at the same time being light in weight.

In connection with the initially mentioned features this object is attained since the actuator element is manufactured of a plastic material.

An electrical conductor is applied to the actuator element. The electrical conductor possesses a suitably low resistance so that it is heated when conducting current and consequently the actuator element with the valve seat thereon is bent in order to assume a certain position in relation to at least one opening in the housing, through which the fluid may flow. In the case of such small dimensions the actuator element of plastic is particularly simple to manufacture and form by shaping methods such as milling, casting or sawing. The actuator element may for example be machined starting at an even plastic surface by embossing a raised temperature or by the use of a laser.

Further advantageous developments of the invention are defined in the claims.

The microvalve with the plastic actuator element is particularly economic to manufacture. More particularly, the sealing seat and the nozzle faces may be produced in a particularly expedient manner using plastic molding technology for fluid systems. Therefore a microvalve with an actuator element formed integrally with a part of the housing is superior to conventional actuator elements of micromachined silicon. Furthermore, it is possible for actuator elements of plastic to be optimally shaped in plastic molding technology with a view to the freedom of movement and accordingly it may be set as regards the possible stroke of motion.

In accordance with a further development of the invention the elongated actuator element is secured at one point to the housing and is able to be so deflected at a right angle to its longitudinal direction that in a first closed position it shuts off a first housing opening and in a second closed position it shuts of a second housing opening. Accordingly in the first closed position on the one hand the power duct or the inlet to the valve chamber is sealed off, the housing opening being respectively sealed off by the valve seat. In this case either venting is prevented, whereas the flow of the fluid is rendered possible, or the fluid duct is shut off and venting is possible.

The elongated actuator element may be formed together with a part of the housing, it being essentially arranged in the same plane as the part of the housing. The microvalve preferably comprises two housing parts, which are laterally placed and more particularly bonded on the part of the housing manufactured of plastic material. The two housing parts are hence laterally applied to the part of the housing which is connected with the actuator element. Since the actuator element and the part of the housing are made of plastic material, there is the possibility of manufacturing the microvalve economically, the thermomechanical behavior, the i. e. the different degrees of thermal expansion of the electrical conductor and the actuator element, being readily selected by the use of different plastic materials for the actuator element. This will also apply for a design of the actuator element irrespectively of the housing.

Therefore it is a question of an economically priced actuator element suitable for many applications as for example in the case of machine tools or materials handling equipment, the performance thereof being able to be simply changed by the use of the plastic material.

The two housing parts mounted laterally on the center part of the housing fitted with the actuator element can be produced using conventional technology by means of microinjection molding technology or also by means of hot embossing.

In the case of one advantageous design of the microvalve the actuator element including the electrical conductor is produced by hot embossing and constitutes an economically priced hot embossed component.

Preferably the actuator element and the part of the housing connected with it are integrally formed and are arranged essentially in a single plane. The part of the housing may in this case constitute a plastic frame, on which the elongated actuator element is attached on one side. The actuator element and the part in the form of a plastic frame of the housing then are preferably essentially in a single plane. Both of them may be manufactured using plastic molding technology or by embossing or stamping. For a higher degree of precision in the case of small dimensions hot embossing technology is possible. On the actuator element manufactured of plastic material side or furthermore on both sides printed wiring is applied in order to cause mechanical deformation of the actuator element during operation of the microvalve on the basis of the different thermal expansion properties of plastic and metal. In addition the one side of the actuator element may also be provided with a hot embossing or embossable foil as an electrical conductor, which in the course of the following production process is additionally metallized by electro-deposition and accordingly may have a greater thickness.

Dependent on the particular requirement as regards rigidity of the actuator element or, respectively, dependent on the fluid pressure to be switched by the microvalve, it is possible for the actuator element to be attached or hinged at one or both sides.

In the case of a preferred further development of the invention the actuator element is connected with the housing on one side and the free end of the actuator element is provided at two oppositely placed sides of the actuator element with respectively one closure portion in order, during deflection in one direction, to close a first housing opening and in the case of opposite deflection to close a second housing opening. The first housing opening is in this case preferably a fluid inlet opening and the second housing opening may for example be a venting opening. A third housing opening serves as a power duct, which is provided with a fluid supply duct or fluid line for the actuator to be operated, as for example a fluid power cylinder. In the first position of the actuator element, in the case of which the first housing opening is closed, for example the valve chamber is vented by way of the venting opening, that is to say fluid is removed in order to reduce fluid pressure in the fluid power duct. In the second position of the actuator element, in the case of which the second housing opening is closed, the fluid may be supplied from the inlet duct into the power duct so that for example a piston of an actuator connected therewith may be set in position.

The fluid may be a gaseous medium, as for instance compressed air, or it may be a hydraulic medium, as for example hydraulic oil.

The free end of the actuator element may be supported in a guide or it using an elastic element on the housing. The elastic element may connect the free end of the actuator element with part of the housing with an elastically supporting action allowing movement so that the free end of the actuator element is only able to be deflected to a certain degree and is urged back by an elastic element providing a return force into a neutral position. In contradistinction to this however a guide groove may be provided as well, in which the free end of the actuator element runs for sliding motion.

The microvalve in accordance with the invention more particularly operates in accordance with a so-called thermomechanical actuation principle. Accordingly the valve member comprises for example either a diaphragm-like or an elongated, tongue-like actuator element, which is able to be bent at a right angle to the direction of the extent or, respectively, longitudinal direction elastically. As an electrical conductor an electrically conducting material is provided on the actuator element, such material being heated by the flow of electric current through it. The valve member bends in accordance with its geometry owing to the different thermal expansion behavior of the actuator element and the electric conductor. Given a suitable geometry and a suitable selection of the materials a desired housing opening may be either completely closed by the valve member or it is possible for its cross section to be so altered that the flow of the fluid through it is reduced.

In the case of a further preferred further development of the invention the actuator element is movingly supported like a seesaw in the housing, two free ends being respectively provided with a closure portion in order selectively in a first switching position to close a first housing opening with one closure portion and to open the second housing opening and in a further switching position to close the second housing opening with the other valve seat and to open the other first housing opening. The microvalve in this respect has a seesaw-like valve member within the valve chamber which in one terminal position of the seesaw-like actuator element closes the one housing opening and in the other terminal position closes the other housing opening. The seesaw-like deflection is produced by support part attached to the housing on the one hand and on the other hand connected with a preferably frame-like section of the actuator element, at least one electric conductor being applied to the support part. The support part is so arranged and designed that when the electric conductor heats up the actuator element is deflected into the one or the other switching position.

The support element may be produced within a frame-like section of the actuator element and essentially in the same plane as the actuator element. The one end of the support element is then connected with the free end of the support element is then connected with the free end of the frame-like section of the actuator element and on the other hand fixed to the housing, more particularly on the inner side of the valve chamber. If the support part bends owing to heating of the electric conductor, the seesaw-like section of the actuator element will be pivoted in relation to the valve chamber with the result that the actuator element is moved into the desired position of switching.

In the case of another development of the invention the actuator element may be stellate in shape, it having at least three and preferably four arms, of which several are fixed to the inner side of the valve chamber and more particularly at the edge thereof. On the arms or more particularly at the center point of intersection of this actuator element designed in this manner there is then at least one closure portion, which for its part is able to be deflected into a closed position for one or more housing openings owing to bending of the actuator element. On one or more arms of this stellate actuator element at least one electric conductor is applied in turn, which during electrical heating by an electric current provides for a different thermal expansion to that of the material of the actuator element. It is in this manner that the deflection of the valve member may be suitably set.

The at least one electric conductor can be provided on the actuator element as a lamination or a branch conductor. An additional opening or recess may be provided on the actuator element in order to permit fluid exchange from the one side of the flat actuator element to the other side so that there is a prompt pressure equalization of the fluid within the valve chamber.

Further advantageous developments and convenient forms of the invention will be understood from the following detailed descriptive disclosure of embodiments thereof in conjunction with the accompanying drawings.

### LIST OF THE SEVERAL VIEWS OF THE FIGURES.

FIG. 1 is a longitudinal section taken through a first embodiment of the microvalve in accordance with the invention shown with considerable magnification.

FIG. 2 shows a sectioned representation of the microvalve in a plan view of the valve member in accordance with the design of FIG. 1.

FIG. 3 is a diagrammatic representation of a second embodiment of the valve member in accordance with the invention for a microvalve.

FIG. 4 is a longitudinal section taken through a microvalve having the valve member as in FIG. 3.

FIG. 5 shows a further working embodiment of the microvalve in a manner representation as in FIG. 2.

### DETAILED ACCOUNT OF WORKING EMBODIMENTS OF THE INVENTION.

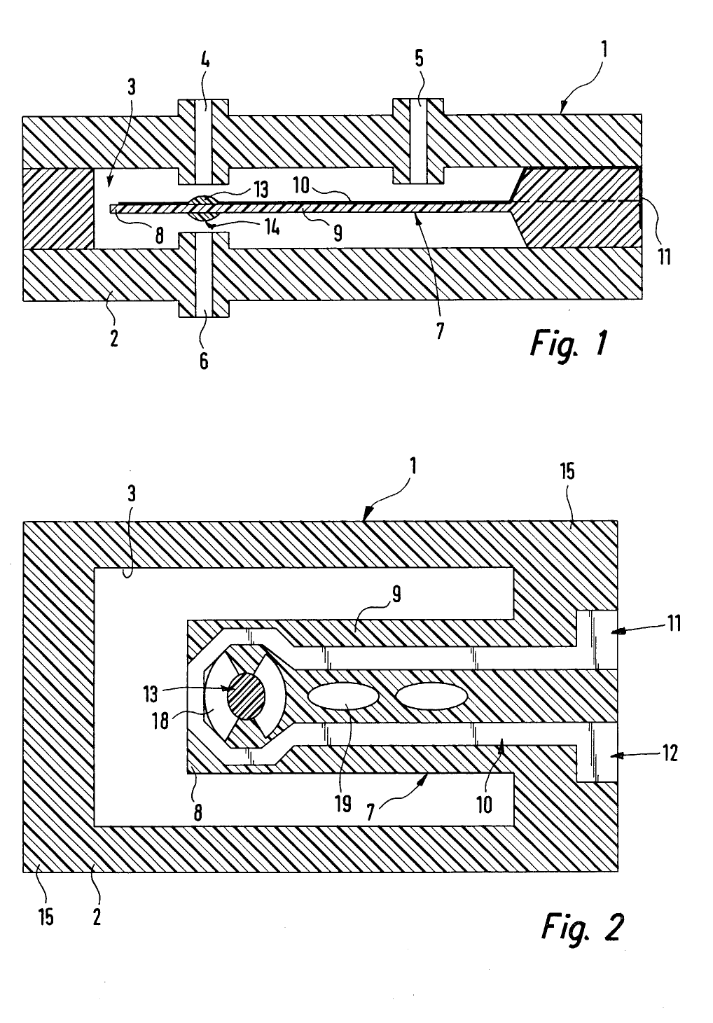

The microvalve 1 in accordance with FIG. 1 as a first embodiment of the invention comprises a housing 2 with a internally formed valve chamber 3. The housing 2 has a first housing opening 4, which serve for the supply of a fluid, more particularly compressed air, and may be termed an inlet duct. A second housing opening 5 constitutes a power duct. To the outside on the housing or in the respective opening fluid ports are provided for the connection of fluid ducts with the housing openings 4 and 5. A third housing opening 6 is provided as a venting duct, although as an alternative it may serve as a further supply or power duct.

The microvalve 1 is connected by way of housing opening 4 with a source of pressure, by way of the second housing opening 5 with the actuator to be operated and by way of the third housing opening 6 with a pressure sink, more particularly with the atmosphere. Should the fluid not be compressed air but a hydraulic oil or some other hydraulic medium, the third housing opening 6 may constitute an exit duct.

Within the valve chamber 3 a valve member 7 is provided, which on one side is secured to the housing 2 and has a free end 8. The valve member 7 is in the form of an essentially elongated, tabular element with at least two layers. The first layer forms the actuator element 9 on which an electrical conductor 10 in the form of a conductor layer is bonded is some manner. The electrical conductor 10 is able to be connected by way of leads 11 and 12 with a source of current so that the electrical conductor may be heated by the flow of electric current. Owing to the heating of the electrical conductor its material expands, something owing to the different coefficients of thermal expansion of the plastic material of the actuator element 9 and of the metal of the electrical conductor 10 causes bending of the valve member 7 in a direction perpendicular to its longitudinal axis.

At points respectively adjacent to the first housing opening 4 and the third housing opening 6 the valve member 7 possesses a first closure portion 13 and a second closure portion 14. When a suitable level of current flows along the electrical conductor 10 a deflection of the valve member 7 may be caused in order to open or close the above mentioned housing openings 4 and 6 at will. To the extent that the valve member 7 in the first closed position closes the first housing opening 4, the first closure portion 13 will be in sealing engagement with the inner side of the first housing opening 4, which here possesses a valve seat. In the opposite second closed position the valve member 7 has the second closure portion 14 in sealing engagement with the third housing opening 6. The respectively opened housing opening communicates with the second housing opening 5. Accordingly a 3/2 valve function may be produced.

In the illustrated embodiment the two closure portions 13 and 14 are arranged respectively on opposite sides on the valve member 7. Dependent on the design of the valve chamber with the respective housing openings 4, 5 and 6 however the closure portions, which are to be closed, can be arranged at different points on the valve member 7. The microvalve can also have still further housing openings, which may be additionally controlled with the same valve member 7,it only being necessary to arrange one further closure portion on the actuator element 9.

Dependent on the design of the microvalve 1 the electrical conductor 10 (it may be a question of only one or of several electrical conductors 10) may be arranged on either one side of the actuator element 9 so that the actuator element 9 is able to be deflected out of a center neutral position into the first closed position. However, electrical conductors can be arranged on either side of the actuator element 9, such conductors deflecting the valve member 7 into the first closed position and on actuation of the other, oppositely placed electrical conductor into the other second closed position.

If the electrical conductor 10, as in the working embodiment, is only applied on one side on the actuator element 9, the second position may also produced by mechanical biasing of the valve member 7 toward the second position. Movement into the second position may be caused by a flow effect of the fluid or at least supported thereby.

As shown in FIG. 2 the housing opening 9 is preferably in the form a flat, even part, on whose one side the electrical conductor is applied in the form of a conductor branch. Together with a part 15 of the housing 2 the actuator element 9 designed in the form of a flat or sheet-like element and consists of a plastic material. Preferably the actuator element 9 is produced with a part of the housing 2 from a single plastic element, the part forming the valve member 3 being for example sawn or carved out of the plastic's surface. Injection molding or casting would be a further possible method of production. This means that an even structure is produced, the part 15 of the housing 2 forming an annular or frame-like element and the actuator element 9 projecting in its inner portion. On the top side and bottom side of the even part 15, represented in FIG. 2, of the housing 2 two coverlike housing parts 17 may be mounted so that a closed valve chamber 3 is produced.

The actuator element 9 preferably has one or more openings 18 and 19 so that the fluid is not held back on the actuator element 9 and a rapid compensating flow takes place..

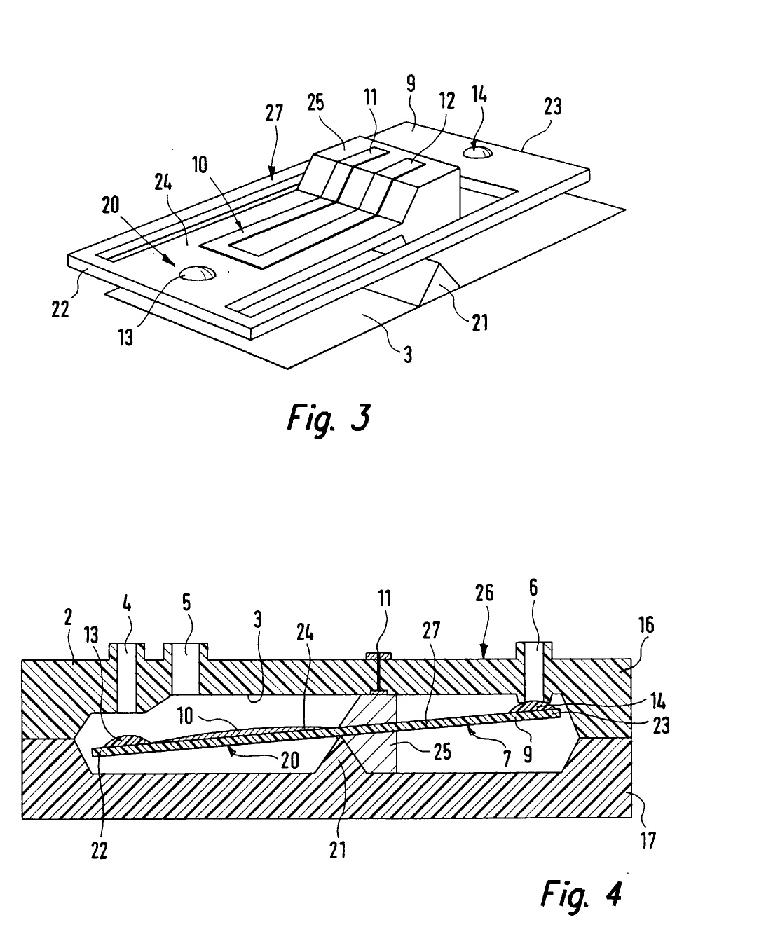

FIG. 3 shows a valve member 20 in accordance with a second embodiment. Here the valve member 20 is pivotally mounted within the valve chamber 3 like a seesaw. The actuator element 27 has a section 27 designed like a frame, which is more particularly centrally mounted on a rib 21 attached to the housing and pivots about it. The frame-like section 21 of the actuator element 9 forms two free ends 22 and 23 in relation to the rib 21. A support part 24, which also belongs to the actuator element 9, is within the frame-like section 27 and is permanently connected with the one free end 22 of the section 27 of the actuator element 9. From this position it extends like a lug into the portion surrounded by the section 27, an attachment element 25 being provided at its other end 24, such element 25 being able to be clamped within the valve chamber and accordingly is able to be permanently clamped to the housing 2. Another type of attachment is possible as well. The electrical conductor 10 extends along the support part 24, and possibly along the frame-like section 27 of the actuator element 9, and is connected by means of two electrical leads 11 and 12 electrically with a source of current, not illustrated.

In FIG. 4 the entire microvalve 26 in accordance with the second embodiment of the invention is represented with the actuator element 9 in the manner of a seesaw, parts, which are the same as in the first embodiment, being provided with the same reference numerals. The housing 2 comprises two separate parts 16 and 17, which may be produced of plastic material. Furthermore, the actuator element 9 preferably comprises a plastic material.

A microvalve 26, in the case of which both the housing 2 and also the actuator element 9 are manufactured of plastic material, is simple to produce. More particularly the principal structures may be produced in a better fashion by plastic molding technology for fluid power systems than using conventional silicon micromachining. The actuator element 9 may be optimally designed for freedom of motion using plastic molding and for example may biased on one direction or may be readily designed in any desired form.

Owing to the seesaw design of the valve member 20 or, respectively, of the actuator element 9 it is possible for so-called 3/2 way valves to be produced or emulated in a simple manner, in the case of which both or all fluid ports 4, 5 and 6 are arranged on a common housing side which in FIG. 4 is illustrated on the top. A further advantage of plastic production technology is that the actuator element 9 is not impaired by dirt in its function as a flexural transducer, as might for example be the case with electrostatic actuator elements, which do not consist of plastic material. The actuator element 9 and the valve chamber 3 are preferably coated with an oil and water repelling material, more particularly one of PTFE, in a CVD process in order to flush traces of oil and water from the pneumatic system and out of the valve chamber 3 of the microvalve 26. This means that deposits may be avoided in the valve chamber 3 and in the entire system too.

The microvalve 26 functions in the following manner: for example the actuator element 9 is not subjected to flow in the position indicated in FIG. 4, the third housing opening 6 being sealed off by the valve seat 14 at the free end 23 of the actuator element. The closing force may be supplied by the suitably biased support part 24. At the same time the first housing opening 4 is opened so that flow may thence may take place by way of the valve chamber 3 into the second housing opening 5. If the electrical conductor 10 is supplied with current by way of the electrical leads 11 and 12 the electrical conductor 10 will be heated owing to its low resistance and the resulting high amperage. The electrical conductor 10 will accordingly expand, the degree of its expansion being different to that of the expansion of the portion of the actuator element 9, on which the electrical conductor is applied. Owing to the different coefficients of thermal expansion of the two layers the support part 24 will deform, and because the support part 24 is connected with the frame-like section 27 of the actuator element 9, the free end 22 of the valve member 20 will be deflected upward, since the support part is held at its other end by way of the attachment element 25 on the housing. Given a suitable selection of the different coefficients of thermal expansion the free end 22 will move, owing to heating of the electrical conductor 10, toward the first housing opening 4, the closure portion 13 will shut off the first housing opening 4 and the closure portion 14 will simultaneously free the third housing opening 6 so that a flow of fluid through the housing openings 5 and 6 may take place.

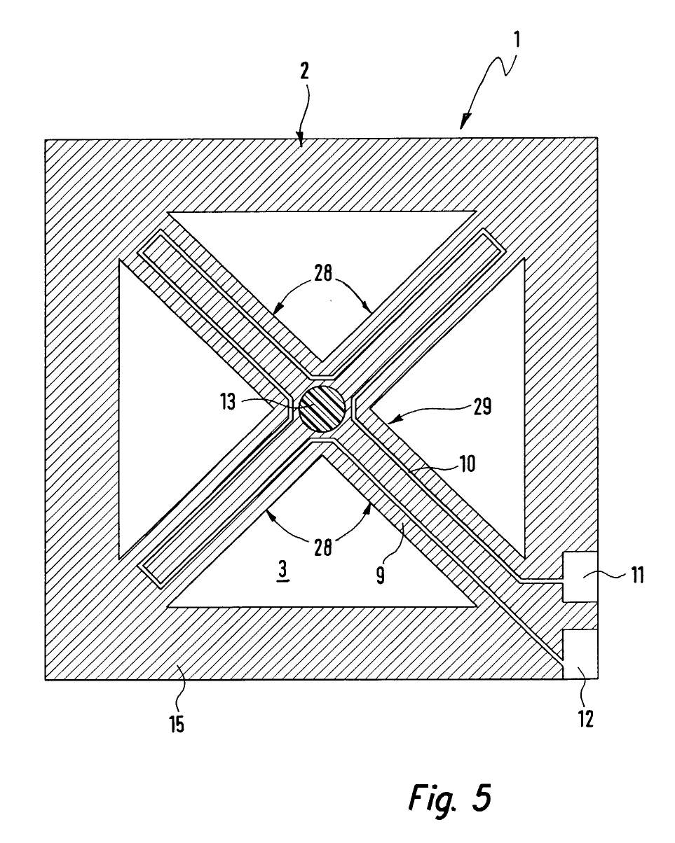

In the case of a further embodiment depicted in FIG. 5 the valve member 29 is stellate or star-like in form and possesses an actuator element 9 with four arms 28, at least one closure portion 13 being provided in the central portion and the arms 28 of the stellate valve member have their outer ends secured on the housing 2 adjacent to the valve chamber 3. On one or more arms 28 an electrical conductor 10 is again attached, whose conduction of current and whose thermal expansion lead to bending and accordingly deflection of the centrally arranged closure portion 13.

Dependent on the particular design with one or more electrical conductors a microvalve 1 provided with a stellate valve member 29 can serve two or more housing openings. Furthermore the number of the arms 28 of the actuator element 9 may be varied so that for example only three arms 28 are provided.

1. A microvalve comprising a housing delimiting a valve chamber, such valve chamber being connected with housing openings forming fluid ducts, a valve member arranged within the valve chamber, such valve member being composed of an elongated actuator element attached at one point on the housing, and at least one electrical conductor arranged on the actuator element, the thermal expansion properties of the electrical conductor being different to those of the actuator element and causing deflection of the valve member into at least one position, wherein the actuator element is formed of a plastic material.

2. The microvalve as set forth in claim 1, wherein the housing is in the form of a multi-part structure, the actuator element being formed of a plastic material together with a part of the housing.

3. The microvalve as set forth in claim 1, wherein a part of the housing and the actuator element are integrally formed and preferably are arranged essentially in a single plane.

4. The microvalve as set forth in claim 1, wherein the actuator element is joined with the housing at one point and at two oppositely placed portions of the actuator element is provided respectively with a closure portion in order, during deflection in the one direction, to close a first opening and during opposite deflection to close a second housing opening.

5. The microvalve as set forth in claim 1, wherein a free end of the actuator element is mounted in a guide or by means of an elastic element for movement in relation to the housing.

6. The microvalve as set forth in claim 1, wherein the valve member is arranged like a seesaw in the housing, two free ends respectively provided with at least one closure portion in order for one closure portion to close a first housing opening in a first position while opening a second housing opening and in a second position to close the second housing opening while opening the first housing opening.

7. The microvalve as set forth in claim 6, having a third housing opening, which is connected with the respectively opened first or second housing opening.

8. The microvalve as set forth in claim 6, wherein all housing openings are arranged to the same side of the actuator element on the housing.

9. The microvalve as set forth in claim 6, wherein a free end of the actuator element is connected with a support part secured to the housing, on which support part at least a part of the electrical conductor is applied in order to deflect the actuator element.

10. The microvalve as set forth in claim 9, wherein the support element is arranged within a frame-like section of the actuator element.

11. The microvalve as set forth in claim 1, wherein the actuator element possesses a plurality of arms movingly supported on the housing, at whose point of intersection at least one closure portion is arranged.

12. The microvalve as set forth in claim 1, wherein at least one branch of the electrical conductor is provided on one face of the actuator element.

13. The microvalve as set forth in claim 1, wherein the actuator element is provided with at least one hole therethrough, which permits a rapid equalization of pressure.

14. The microvalve as set forth in claim 1, wherein the actuator element including the electrical conductor is formed as a thermally embossed component.
